(19) United States
(12) Patent Application Publication
(10) Pub. No.: US 2015/0145224 A1
(43) Pub. Date: May 28, 2015

(54) COLLAPSIBLE CART

(71) Applicant: Shou Qiang ZHU, Ontario, CA (US)

(72) Inventor: Shou Qiang ZHU, Ontario, CA (US)

(21) Appl. No.: 14/463,678

(22) Filed: Aug. 20, 2014

Related U.S. Application Data
(60) Provisional application No. 61/907,395, filed on Nov. 22, 2013.

(51) Int. Cl. B62B 3/02

(52) U.S. Cl. CPC B62B 3/025
USPC 280/42

(57) ABSTRACT

A collapsible cart may include a handle; a first supporting frame; a second supporting frame; and a connecting member including a plurality of connecting units and connecting rods, wherein the connecting units and the connecting rods are pivotally connected to the first supporting frame and the second supporting frame, so when the first supporting frame and second supporting frame are moved toward each other, the movement of the two supporting frames triggers the collapse of the connecting member to minimize the size of the cart.

### CROSS-REFERENCE TO RELATED APPLICATIONS

This application claims priority under 35 U.S.C. §119 (e) to U.S. Provisional Patent Application Ser. No. 61/907,395, filed on Nov. 22, 2013, the entire contents of which are hereby incorporated by reference.

### FIELD OF THE INVENTION

The present invention is directed to a collapsible and portable cart, and in particular to a collapsible cart that can be used to store and transported various items, and the size of the cart can be easily minimized when not in use.

### BACKGROUND OF THE INVENTION

In recent years, more and more people love outdoor and recreational activities such as camping, field trips, or Bar-B-Q during their free time because many people may endure high pressure at work, and have accumulated a lot of tension and stress. Not only can these outdoor activities help people release the stress, but also improve quality of life. When people enjoy their outdoor activities, carts are primarily used for storing and transporting food, groceries and Bar-B-Q items, and even little child can be put therein.

Throughout the time, portable carts have been developed so the carts can be transported in a confined space (such as vehicle trunk), and quickly converted into a three-dimensional space supported by wheels to store and transport a plurality of items when arriving the outdoor destination such as parks, camping site, beaches, etc. U.S. Pat. No. 5,738,365 to McCarthy discloses a collapsible cart including a base member, first and second double L-shaped brackets, a pair of locking pins, and two locking bar members. The locking bar members and locking pins are utilized to lock the double L-shaped brackets into place when the cart is in the un-collapsed configuration.

U.S. Pat. No. 6,685,199 to Stravitz et al. discloses a collapsible frame which is readily folded up into a closed position having a narrow lateral profile and folded open back into the fully open position when needed. In the fully open position the cart will structurally support a storage container full of files or other items. No tools or other means are needed to fold up the cart into the folded position or to unfold the cart back into the fully open position.

However, the collapsible carts disclosed above may have too many conjugating points that would weaken the structure of the collapsible carts. It is also inconvenient for the user to engage/disengage every conjugating points when the user wants to use or store them. Therefore, there remains a need for a new and improved collapsible cart that is more convenient and efficient for the user to open up or store without putting any additional or unnecessary burden on the users.

### SUMMARY OF THE INVENTION

It is an object of the present invention to provide a collapsible cart that can be stored and moved more conveniently and efficiently without putting any additional or unnecessary burden on the users.

It is another object of the present invention to provide a collapsible cart, the size of which can be easily minimized so the user can easily transport the cart to any destination the user wants to go, and uses the cart in the destination, such as a camping spot, park, etc.

In one aspect, a collapsible cart may include a handle, a first supporting frame, and a second supporting frame. The first supporting frame and the second supporting frame are connected with a connecting member. The connecting member may include a plurality of connecting units and a plurality of connecting rods. The connecting member is used not only to connect the first and second supporting frames, but also help collapse the cart to a compact size, so it is convenient for the user to carry it out and store it in the garage or trunk.

In one embodiment, each of the connecting units is U-shaped. An upper portion of the connecting unit is pivotally connected to an upper portion of the second supporting frame. More specifically, the second supporting frame has a horizontal bar and an open end of the U-shaped connecting unit is connected to the second supporting frame slightly below the horizontal bar. Likewise, an upper portion of the connecting unit is pivotally connected to an upper portion of the first supporting frame. More specifically, the first supporting frame has a horizontal bar, and an open end of the U-shaped connecting unit is connected to the first supporting frame slightly below the horizontal bar.

The collapsible cart can be fully extended and a fabric can be disposed in a receiving space created between the first supporting frame and the second supporting frame, and if the user wishes to go picnic, he/she can put food, water, fruit, utensils, etc. in the receiving space. The collapsible cart further includes four wheels, so the cart can be easily operated and moved from one place to another.

It is noted that the connecting member forms a substantially flat surface at the bottom of the receiving space, so when the fabric is disposed in the receiving space, the fabric can be supported by the supporting structure to better protect the objects in the receiving space.

When the user finishes using the cart, the size of the cart can be significantly reduced to just occupy a minimum space. More particularly, the structure of the cart starts to collapse when the user hold the horizontal bars of the first supporting frame and the second supporting frame, and squeeze them toward the center portion of the cart, the movement of the two supporting frames triggers the collapse of the connecting member to minimize the size of the cart.

In another aspect, a collapsible cart may include a handle, a first supporting frame, a second supporting frame, and a connecting member. The connecting member may include a plurality of connecting units, wherein one end of a first connecting unit is pivotally connected to a top portion of one side of the first supporting frame, and the other end thereof is pivotally connected to a bottom portion of one side of the second supporting frame; one end of a second connecting unit is pivotally connected to a top portion of the second supporting frame on the same side as the first connecting unit, and the other end thereof is pivotally connected to a bottom portion of the second supporting frame on the same side as the first connecting unit.

Similarly, on the other side of the cart, one end of a third connecting unit is pivotally connected to the top portion of the other side of the first supporting frame, and the other end thereof is pivotally connected to the bottom portion of the other side of the second supporting frame; and one end of a fourth connecting unit is pivotally connected to the top portion of the first supporting frame, and the other end thereof is pivotally connected to a bottom portion of the second supporting frame.

The collapsible cart also includes a receiving space and a plurality of supporting units and at the bottom thereof. The first supporting unit has a first end and a second end, while the second supporting unit has a first end and a second end, wherein the first end of the first supporting unit is pivotally connected to the bottom portion of the second supporting frame, while the first end of the second supporting unit is pivotally connected to the bottom portion of the first supporting frame. The second ends of the first and second supporting units are pivotally connected to each other at nearly the center portion of the receiving space.

The size of the collapsible cart can also be significantly reduced. More specifically, the supporting unit has a lifting portion, and the cart starts to collapse when the lifting portion is lifted by the user. Since the second ends of the first and second supporting units are pivotally connected to each other, and the first ends of the first and second supporting units are pivotally connected to the second supporting frame and first supporting frame respectively, when the lifting portion is lifted, the first supporting frame and second supporting frame are simultaneously moved toward each other to collapse the cart.

### BRIEF DESCRIPTION OF THE DRAWINGS

FIG. 1 illustrates a prior art of a collapsible cart.

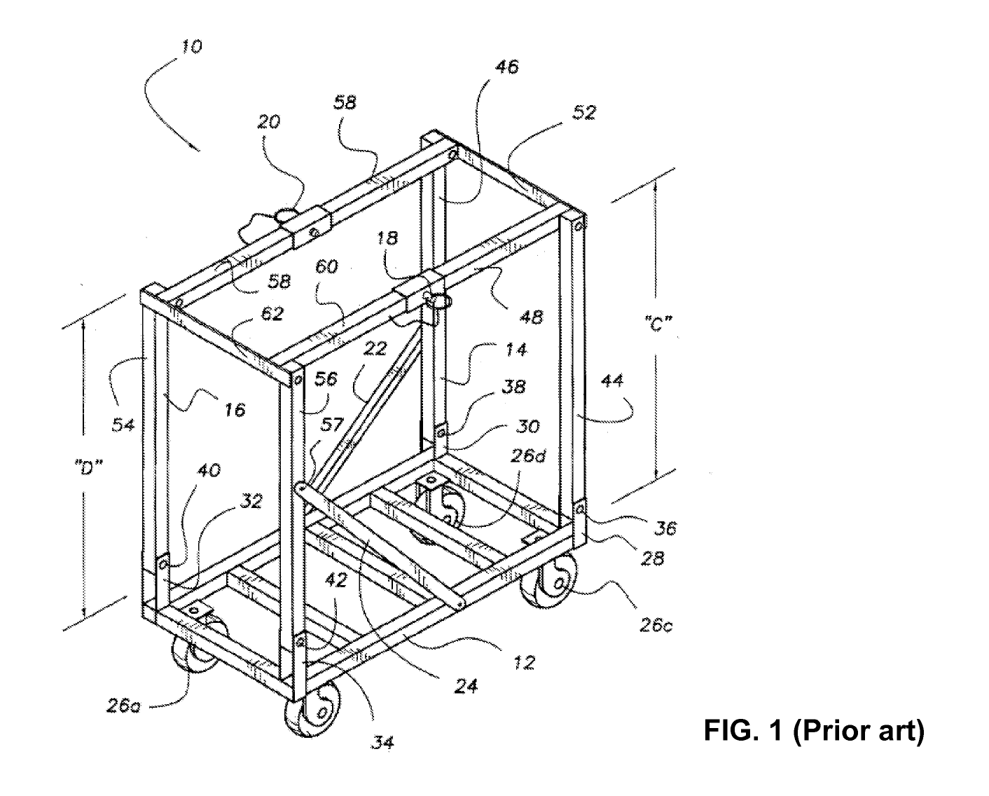

FIG. 2 illustrates another prior art of a collapsible movable cart.

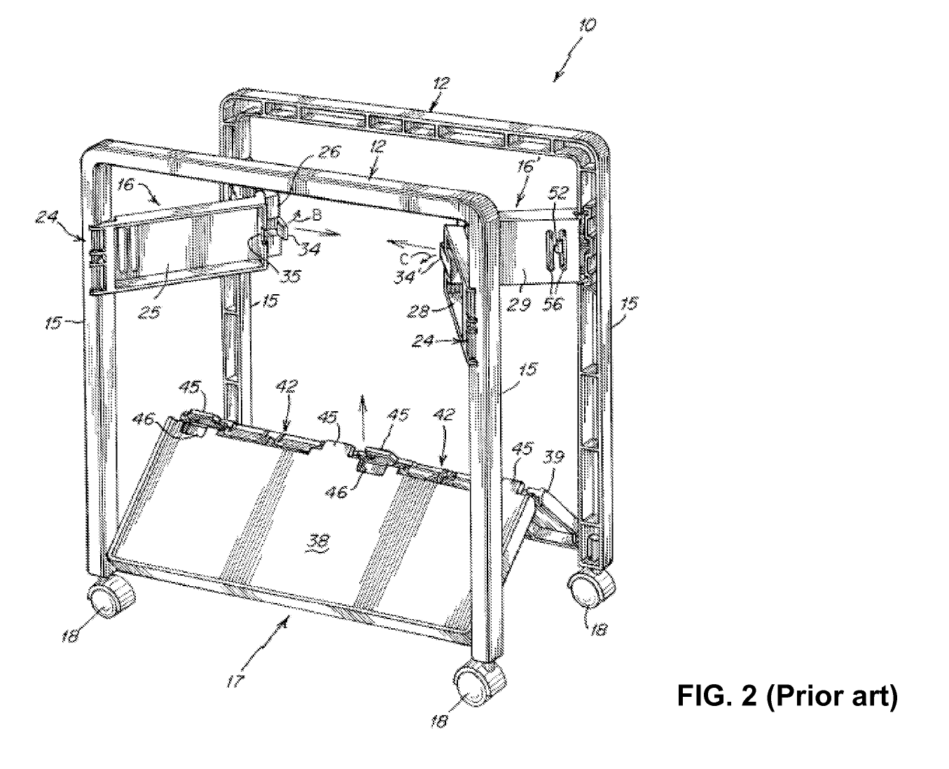

FIG. 3 illustrates a collapsible cart in a fully open status in the present invention.

FIG. 3a illustrates the collapsible cart in a fully open status in the present invention from another angle.

FIG. 4 illustrates the collapsible cart in the present invention that is being minimized.

FIG. 4a illustrates the collapsible cart in the present invention that is being minimized from another angle.

FIG. 5 illustrates the collapsible cart in the present invention with its most minimized size.

FIG. 6 illustrates a different aspect of a collapsible cart in the present invention.

FIG. 7 illustrates the collapsible cart in FIG. 6 that is being minimized.

FIG. 8 illustrates the collapsible cart in FIG. 6 with its most minimized size.

FIG. 9 illustrates a fabric attached to the collapsible cart in FIG. 6 in the present invention.

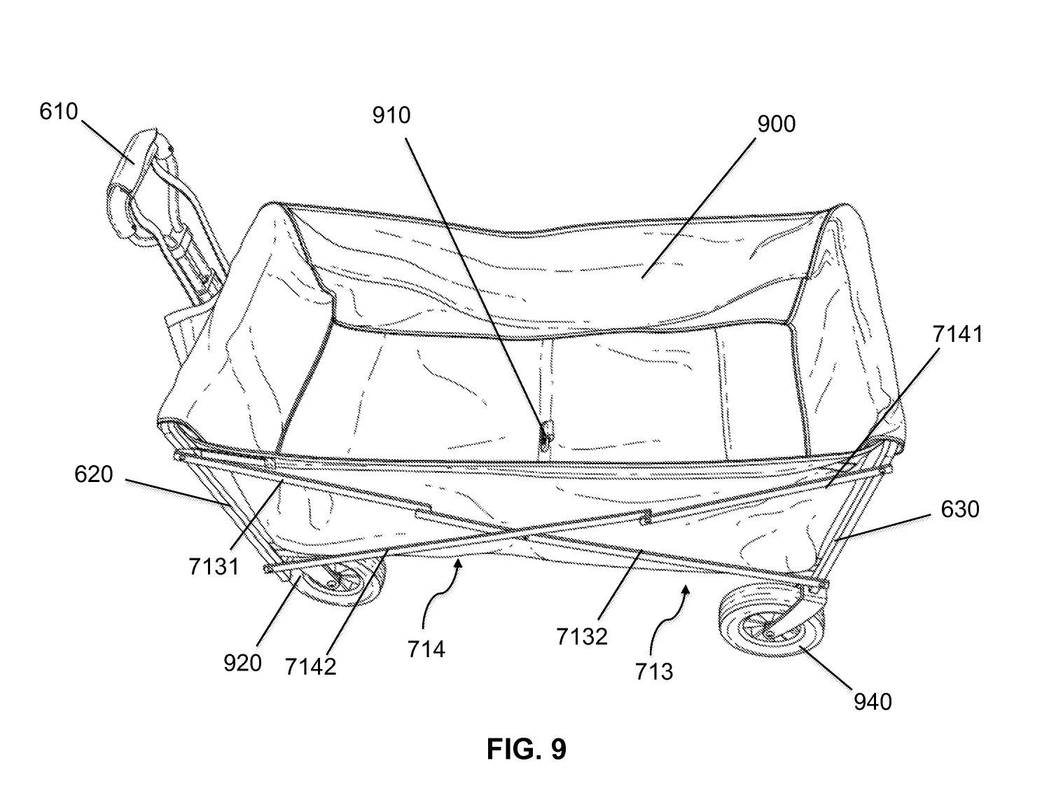

FIG. 10 illustrates the collapsible cart in FIG. 9 that is being minimized.

FIG. 11 illustrates the collapsible cart in FIG. 9 with its most minimized size.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

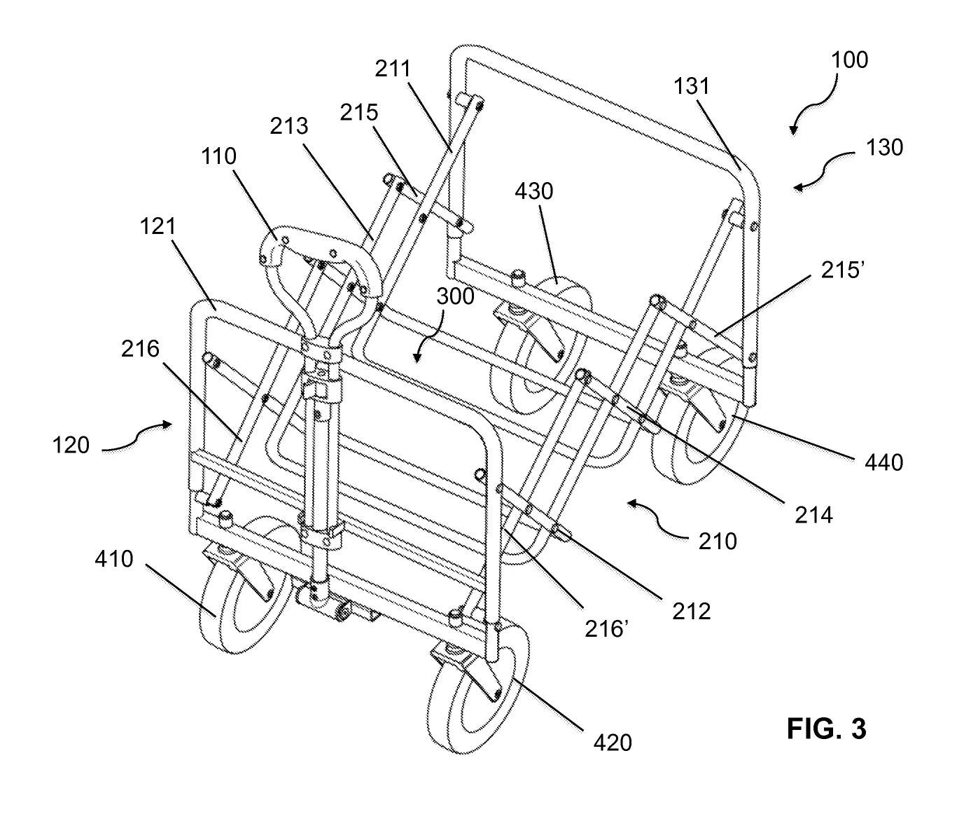

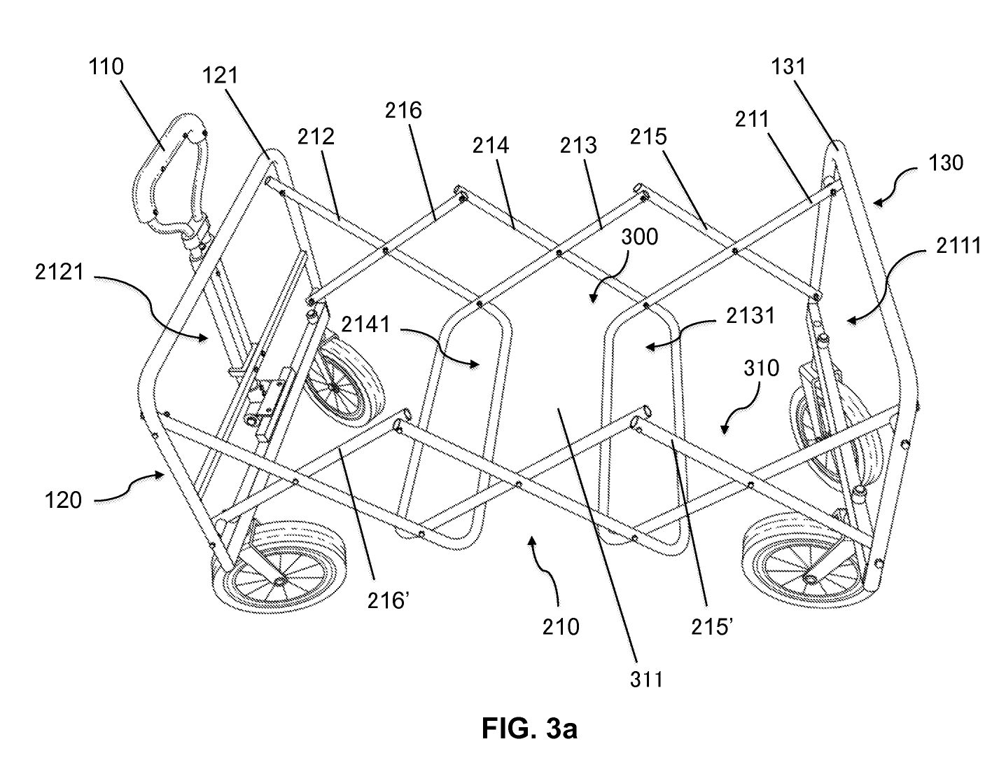

In one aspect, a collapsible cart may include a handle 110, a first supporting frame 120, and a second supporting frame 130. In one embodiment, the handle is movably secured at the first supporting frame 120, and the first supporting frame 120 and the second supporting frame 130 are connected with a connecting member 210, as shown in FIGS. 3 to 5. The connecting member 210 may include a plurality of connecting units (211, 212, 213, 214) and a plurality of connecting rods (215, 215′, 216, 216′). The connecting member 210 is used not only to connect the first and second supporting frames 120 and 130, but also collapse the cart to a compact size, so it is convenient for the user to carry it out and store it in the garage or trunk.

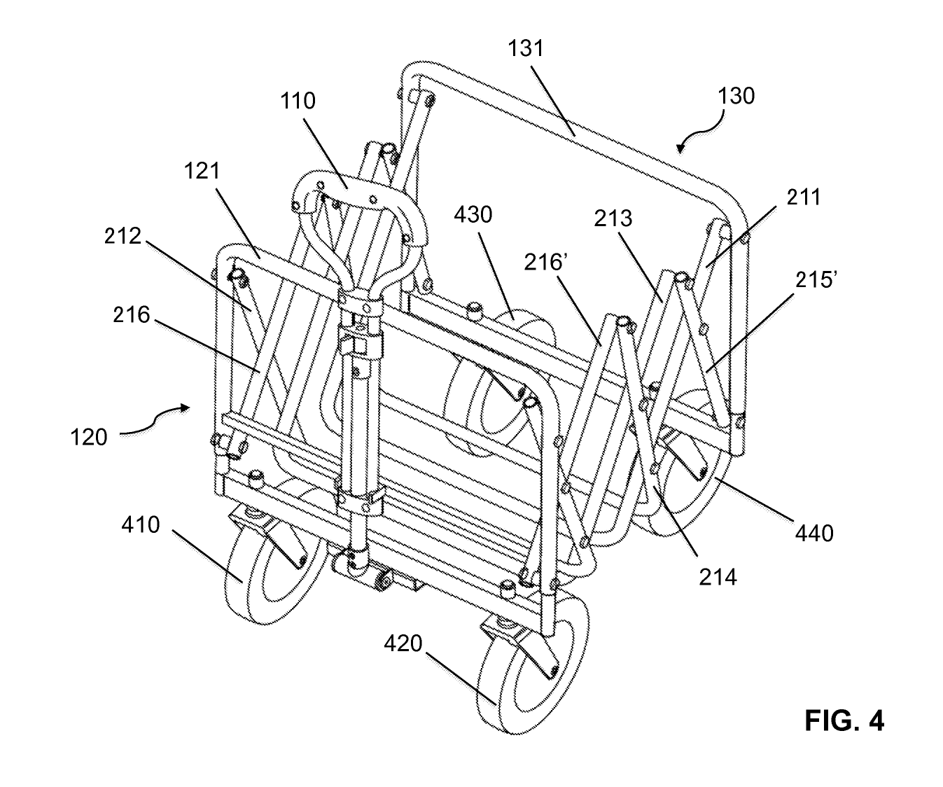

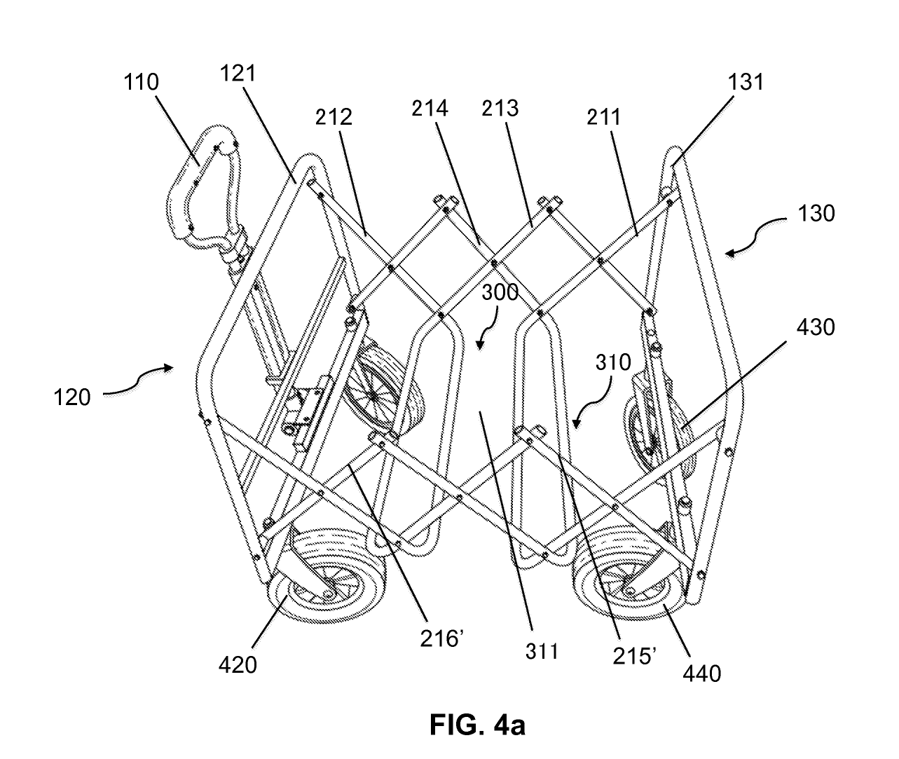

In another embodiment, each of the connecting units (211, 212, 213, 214) is U-shaped. An upper portion of the connecting unit 211 is pivotally connected to an upper portion of the second supporting frame 130. More specifically, the second supporting frame 130 has a horizontal bar 131 and an open end 2111 of the U-shaped connecting unit 211 is connected to the second supporting frame 130 slightly below the horizontal bar 131. Likewise, an upper portion of the connecting unit 212 is pivotally connected to an upper portion of the first supporting frame 120. More specifically, the first supporting frame 120 has a horizontal bar 121, and an open end of the U-shaped connecting unit 212 is connected to the first supporting frame 120 slightly below the horizontal bar 121, as shown in FIGS. 3, 3a, 4 and 4a.

The connecting unit 213 is disposed spacedly and parallelly from the connecting unit 211, and between the connecting units 211 and 212. Like the U-shaped connecting unit 211, the U-shaped connecting unit 213 also has an open end 2131. The connecting rods 215 and 215′ are used to connect the U-shaped connecting units 211 and 213. More specifically, one end of each connecting rods (215, 215′) is pivotally connected to the second supporting frame 130 below the U-shaped connecting unit 211, and the other end is pivotally connected to the open end 2131 of the connecting unit 213. It is noted that near a center portion of each connecting rods (215, 215′) is also pivotally connected to two longer ends of the U-shaped connecting unit 211 at nearly a center portion thereof.

Likewise, the connecting unit 214 is disposed spacedly and parallelly from the connecting unit 212, and between the connecting units 211 and 212. Like the U-shaped connecting unit 212, the U-shaped connecting unit 214 also has an open end 2141. The connecting rods 216 and 216′ are used to connect the U-shaped connecting units 212 and 214. More specifically, one end of each connecting rods (216, 216′) is pivotally connected to the first supporting frame 120 below the U-shaped connecting unit 212, and the other end is pivotally connected to the open end 2141 of the connecting unit 214. It is noted that near a center portion of each connecting rods (216, 216′) is also pivotally connected to two longer ends of the U-shaped connecting unit 212 at nearly a center portion thereof.

As shown in FIGS. 3 and 3a, the collapsible cart is fully extended and a fabric (not shown) can be disposed in a receiving space 300 created between the first supporting frame 120 and the second supporting frame 130, and if the user wishes to go picnic, he/she can put food, water, fruit, utensils, etc. in the receiving space 300. The collapsible cart further includes four wheels (410, 420, 430, 440), wherein the wheels 410 and 420 are disposed at the bottom of the first supporting frame 120, while the wheels 430 and 440 are disposed at the bottom of the second supporting frame 130. With the wheels 410 to 440, the cart can be easily operated and moved from one place to another.

It is noted that the connecting member 210 forms a substantially flat surface 310 at the bottom of the receiving space 300. More specifically, the flat surface 310 includes a supporting structure 311 formed by a horizontal portion 2112 of the connecting unit 211, a horizontal portion 2122 of the connecting unit 212, a horizontal portion 2132 of the connecting unit 213, and a horizontal portion 2142 of the connecting unit 214, wherein the horizontal portions 2112, 2122, 2132 and 2142 are substantially parallel and spaced with each other. Therefore, when the fabric (not shown) is disposed in the receiving space 300, the fabric can be supported by the supporting structure 311 to better protect the objects in the receiving space 300. It is also noted that when the collapsible cart is fully extended, each side of the connecting member 210 seems to have three X-shaped structure pivotally connected with each other as shown in FIG. 3a.

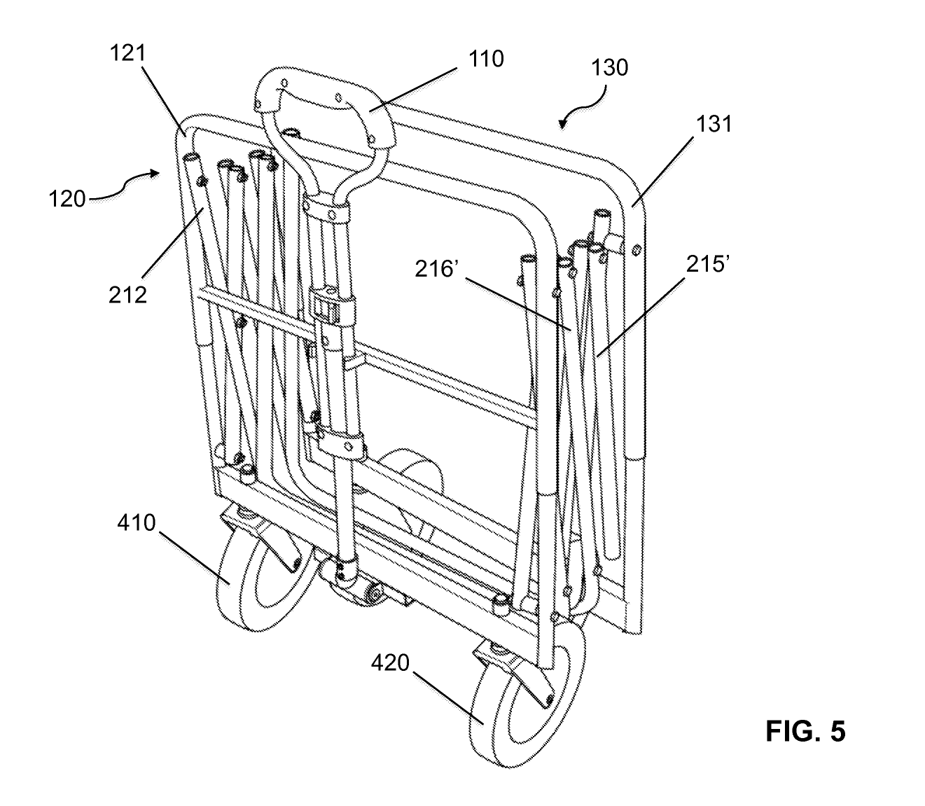

When the user finishes using the cart, the size of the cart can be significantly reduced to just occupy a minimum space. More particularly, the structure of the cart starts to collapse when the user hold the horizontal bar 121 of the first supporting frame 120 and the horizontal bar 131 of the second supporting frame 130, and squeeze them toward the center portion of the cart, as shown in FIGS. 4 and 4a. As discussed above, one end of the connecting rods (215, 215′) and (216, 216′) are pivotally connected to the second supporting frame 130 and first supporting frame 120 respectively, and the connecting units (211, 213) and (212, 214) are pivotally connected with the other end of the connecting rods (215, 215′) and (216, 216′) respectively, so when the first supporting frame 120 and second supporting frame 130 are being moved toward each other, the movement of the two supporting frames triggers the collapse of the connecting member 210 to minimize the size of the cart. The cart can be eventually minimized as shown in FIG. 5.

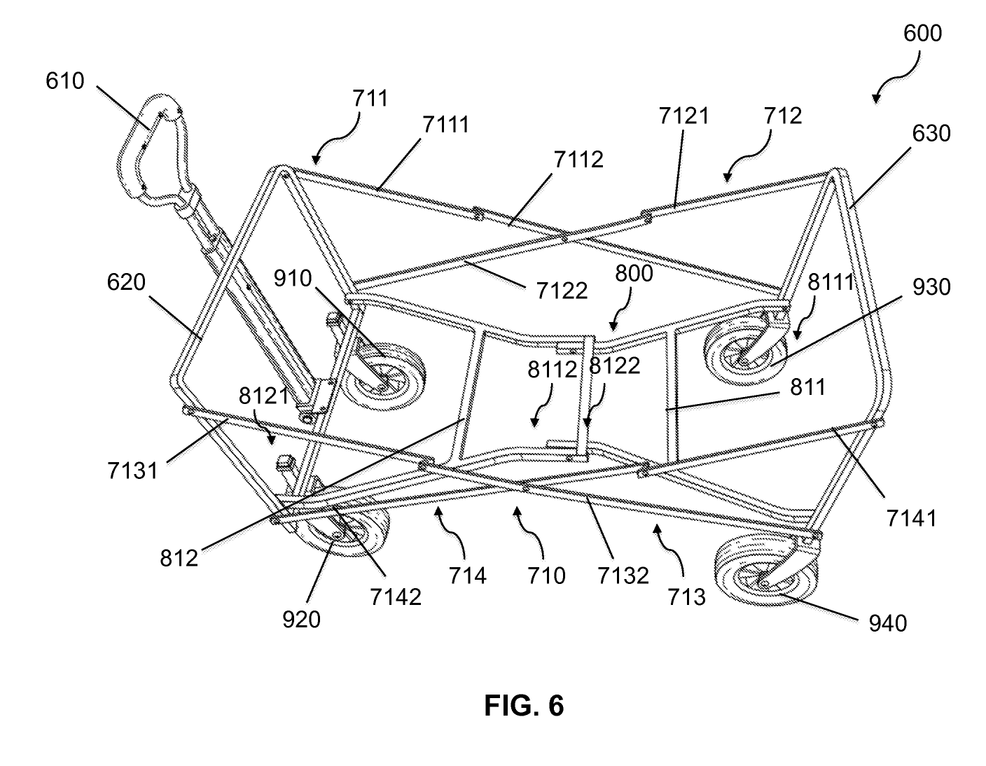

In another aspect shown in FIG. 6, a collapsible cart 600 may include a handle 610, a first supporting frame 620, a second supporting frame 630, and a connecting member 710. The connecting member 710 may include a plurality of connecting units 711, 712, 713 and 714, wherein one end of the connecting unit 711 is pivotally connected to a top portion of one side of the first supporting frame 610, and the other end thereof is pivotally connected to a bottom portion of one side of the second supporting frame 620; one end of the connecting unit 712 is pivotally connected to a top portion of the second supporting frame 620 on the same side as the connecting unit 711, and the other end thereof is pivotally connected to a bottom portion of the second supporting frame 610 on the same side as the connecting unit 711. Similarly, on the other side of the cart 600, one end of the connecting unit 713 is pivotally connected to the top portion of the other side of the first supporting frame 610, and the other end thereof is pivotally connected to the bottom portion of the other side of the second supporting frame 620; and one end of the connecting unit 714 is pivotally connected to the top portion of the first supporting frame 610, and the other end thereof is pivotally connected to a bottom portion of the second supporting frame 620.

More specifically, still referring to FIG. 6, the connecting unit 711 has a first connecting rod 7111 and a second connecting rod 7112, wherein one end of the first connecting rod 7111 is pivotally connected to the top portion of the first supporting frame 620, and the other end there of is pivotally connected to one end of the second connecting rod 7112, and the other end of the second connecting rod 7112 is pivotally connected to the bottom portion of the second supporting frame 630. Likewise, the connecting unit 712 has a first connecting rod 7121 and a second connecting rod 7122, wherein one end of the first connecting rod 7121 is pivotally connected to the top portion of the second supporting frame 620, and the other end there of is pivotally connected to one end of the second connecting rod 7122, and the other end of the second connecting rod 7122 is pivotally connected to the bottom portion of the first supporting frame 620. It is noted that the second connecting rod 7112 of the connecting unit 711 is pivotally connected to the second connecting rod 7122 of the connecting unit 712 at nearly the center portion of the collapsible cart 600. Also, the connecting unit 711 and 712 are pivotally connected on a first side of the collapsible cart 600.

Likewise, the connecting unit 713 has a first connecting rod 7131 and a second connecting rod 7132, wherein one end of the first connecting rod 7131 is pivotally connected to the top portion of the first supporting frame 620, and the other end there of is pivotally connected to one end of the second connecting rod 7132, and the other end of the second connecting rod 7132 is pivotally connected to the bottom portion of the second supporting frame 630. Likewise, the connecting unit 714 has a first connecting rod 7141 and a second connecting rod 7142, wherein one end of the first connecting rod 7141 is pivotally connected to the top portion of the second supporting frame 630, and the other end there of is pivotally connected to one end of the second connecting rod 7142, and the other end of the second connecting rod 7142 is pivotally connected to the bottom portion of the first supporting frame 620. It is noted that the second connecting rod 7132 of the connecting unit 713 is pivotally connected to the second connecting rod 7142 of the connecting unit 714 at nearly the center portion of the collapsible cart 600. Also, the connecting unit 713 and 714 are pivotally connected on a second side of the collapsible cart 600.

The collapsible cart 600 also includes a receiving space 800 and a plurality of supporting units 811 and 812 at the bottom of the receiving space 800. The supporting unit 811 has a first end 8111 and a second end 8112, while the supporting unit 812 has a first end 8121 and a second end 8122, wherein the first end 8111 of the supporting unit 811 is pivotally connected to the bottom portion of the second supporting frame 630, while the first end 8121 of the supporting unit 812 is pivotally connected to the bottom portion of the first supporting frame 620. The second ends (8112, 8122) of the first and second supporting units (811, 812) are pivotally connected to each other at nearly the center portion of the receiving space 800.

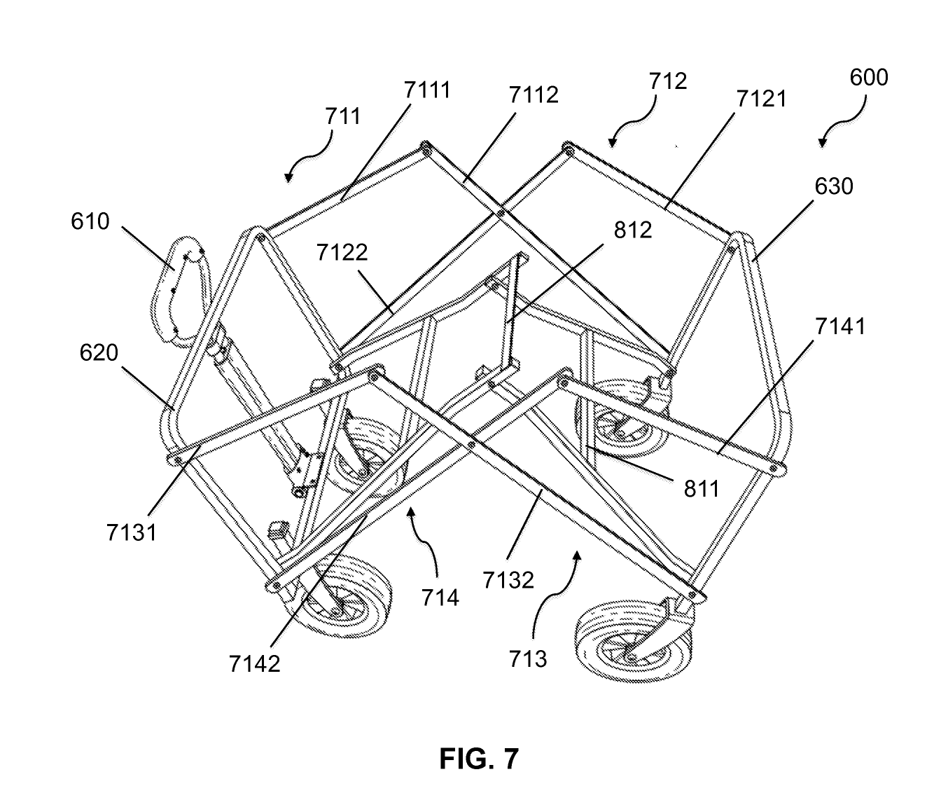

Like the cart 100 discussed above, the size of the collapsible cart 600 can also be significantly reduced. More specifically, the supporting unit 811 has a lifting portion 8113, and the cart 600 starts to collapse when the lifting portion 8113 is lifted by the user. Since the second ends (8112, 8122) of the first and second supporting units (811, 812) are pivotally connected to each other, and the first ends (8111, 8121) of the first and second supporting units (811, 812) are pivotally connected to the second supporting frame 130 and first supporting frame 120 respectively, when the lifting portion 8113 is lifted, the first supporting frame 120 and second supporting frame 130 are simultaneously moved toward each other to collapse the cart 600, as shown in FIG. 7.

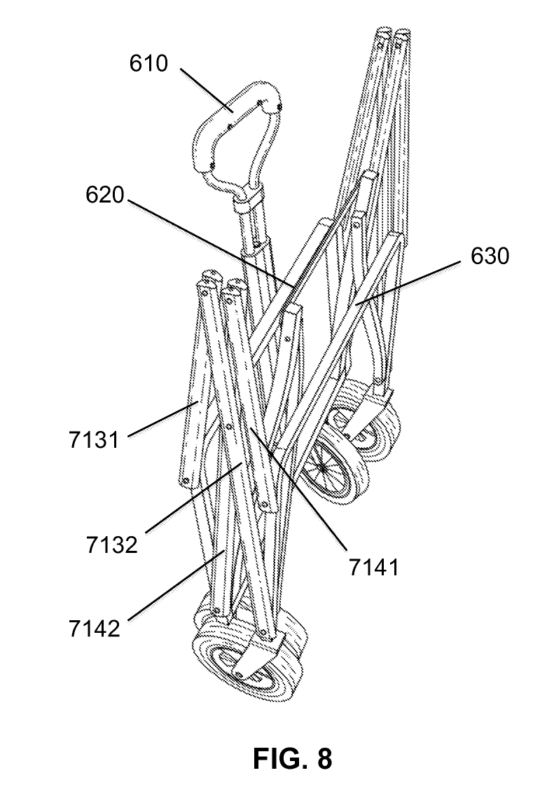

As discussed above, since one end of each of the connecting units 711 to 714 is pivotally connected to either the first supporting frame 120 or the second supporting frame 130, when the cart 600 is collapsed as shown in FIG. 7, the connecting units 711 to 714 are simultaneously deformed due to the movement of the first supporting frame 120 and second supporting frame 130. The size of the cart 600 would be eventually minimized as shown in FIG. 8 when the first and second connecting rods of the connecting units 711 to 714 become nearly vertical to the ground.

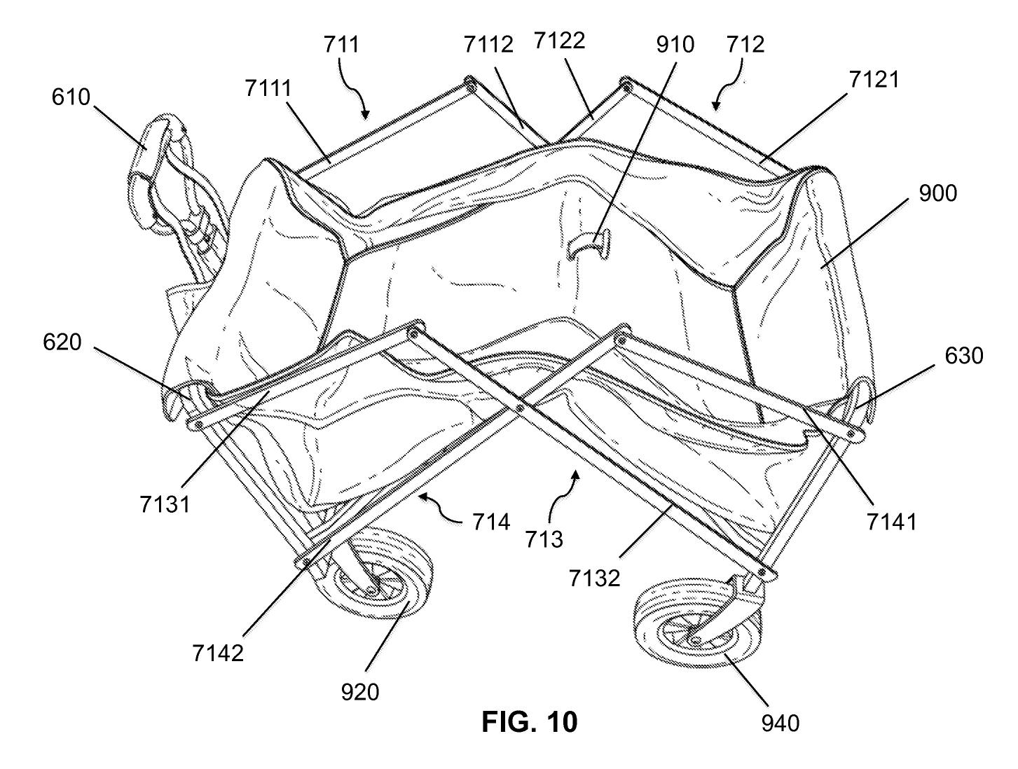

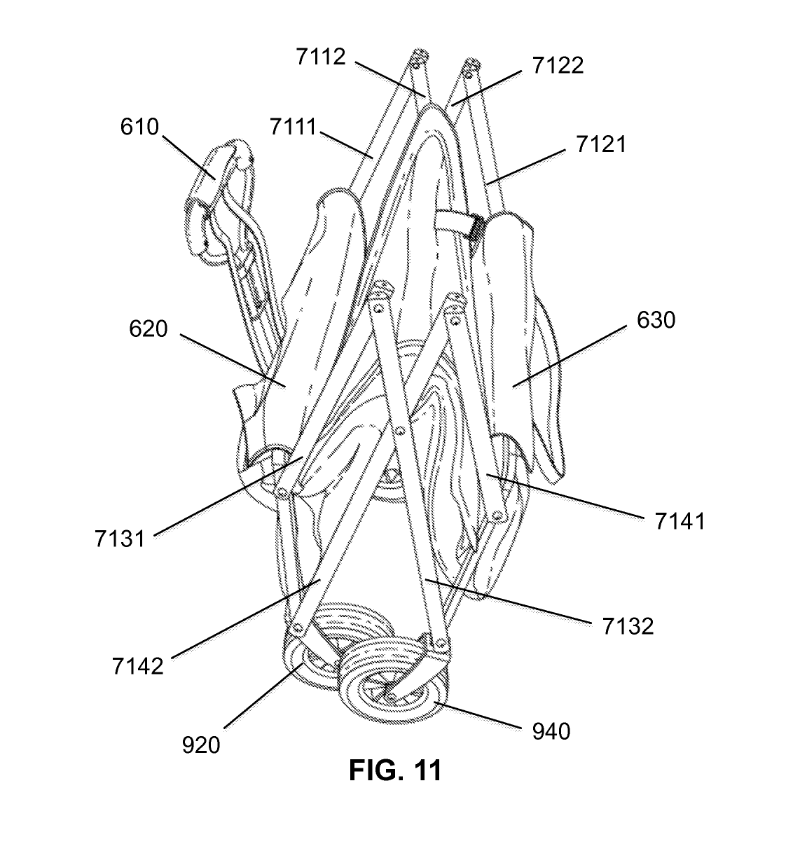

In one embodiment, the collapsible cart 600 further includes a fabric 900 disposed in the receiving space 800. The fabric 900 is secured at the handle 610, the first and second supporting frames 620 and 630, and the supporting unit 811 as shown in FIG. 10. More specifically, a lifting unit 910 of the fabric 900 is attached to the lifting portion 8113 of the supporting unit 811, so when the lifting unit 910 is lifted, the lifting portion 8113 will be simultaneously lifted to start the collapsing process of the cart 600 as shown in FIG. 11. As discussed above, the size of the cart 600 can be eventually minimized as shown in FIG. 12.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A collapsible cart comprising:
a handle;
a first supporting frame;
a second supporting frame; and
a connecting member including a plurality of connecting units and connecting rods,
wherein the connecting units and the connecting rods are pivotally connected to the first supporting frame and the second supporting frame, so when the first supporting frame and second supporting frame are moved toward each other, the movement of the two supporting frames triggers the collapse of the connecting member to minimize the size of the cart.

2. The collapse cart of claim 1, wherein the connecting member has four connecting units and each of the connecting units is U-shaped, and a first open end of a first connecting unit is pivotally connected to the first supporting frame, while a second open end of a second connecting unit is pivotally connected to a second supporting frame.

3. The collapse cart of claim 2, wherein the first supporting frame has a first horizontal bar and the first connecting unit is pivotally connected to the first supporting frame slightly under the first horizontal bar, while the second supporting frame has a second horizontal bar and the second connecting unit is pivotally connected to the second supporting frame slightly under the second horizontal bar.

4. The collapse cart of claim 2, wherein a third connecting unit is disposed spacedly and parallelly from the first connecting unit, and between the first and second connecting units, while a fourth connecting unit is disposed spacedly and parallelly from the second connecting unit, and between the first and second connecting units.

5. The collapse cart of claim 4, wherein one end of each of a first and second connecting rods is pivotally connected to the first supporting frame below the first connecting unit, and the other end is pivotally connected to a third open end of the third connecting unit, while one end of a third and fourth connecting rods is pivotally connected to the second supporting frame below the second connecting unit, and the other end is pivotally connected to a fourth open end of the fourth connecting unit.

6. The collapse cart of claim 5, wherein a receiving surface is created between the first supporting frame and the second supporting frame, and the connecting member forms a substantially flat surface at a bottom of the receiving space.

7. The collapse cart of claim 6, wherein the flat surface includes a supporting structure formed by a first horizontal portion of the first connecting unit, a second horizontal portion of the connecting unit, a third horizontal portion of the third connecting unit, and a fourth horizontal portion of the fourth connecting unit, and said four horizontal portions are substantially parallel and spaced with each other.

8. A collapsible cart comprising
a handle;
a first supporting frame;
a second supporting frame;
a connecting member including a plurality of connecting units to pivotally connect the first supporting frame and the second supporting frame; and
a plurality of supporting units,
wherein the connecting units and the supporting units are pivotally connected to the first supporting frame and the second supporting frame, and when one of the supporting units is lifted, the first supporting frame and second supporting frame are moved toward each other, and the movement of the two supporting frames triggers the collapse of the connecting member to minimize the size of the cart.

9. The collapsible cart of claim 8, wherein the connecting member include four connecting units, wherein one end of a first connecting unit is pivotally connected to a top portion of one side of the first supporting frame, and the other end thereof is pivotally connected to a bottom portion of one side of the second supporting frame; one end of a second connecting unit is pivotally connected to a top portion of the second supporting frame on the same side as the first connecting unit, and the other end thereof is pivotally connected to a bottom portion of the second supporting frame; one end of a third connecting unit is pivotally connected to the top portion on the other side of the first supporting frame, and the other end thereof is pivotally connected to the bottom portion of the other side of the second supporting frame; and one end of a fourth connecting unit is pivotally connected to the top portion of the first supporting frame on the same side of the third connecting unit, and the other end thereof is pivotally connected to a bottom portion of the second supporting frame.

10. The collapsible cart of claim 9, wherein a receiving space is created between the first and second supporting frames, and the supporting units are at the bottom of the receiving space.

11. The collapsible cart of claim 10, wherein a first supporting unit has a first end and a second end, while a second supporting unit has a first end and a second end, wherein the first end of the first supporting unit is pivotally connected to the bottom portion of the second supporting frame, while the first end of the second supporting unit is pivotally connected to the bottom portion of the first supporting frame, and the second ends of the first and second supporting units are pivotally connected to each other at nearly a center portion of the receiving space.

12. The collapsible cart of claim 11, wherein the first supporting unit has a lifting portion, and when the lifting portion is lifted by a user, the first supporting frame and second supporting frame are simultaneously moved toward each other to collapse the cart.
